(19) United States
(12) Patent Application Publication
(10) Pub. No.: US 2026/0097737 A1
(43) Pub. Date: Apr. 9, 2026

(54) VEHICLE CONTROL DEVICE

(71) Applicant: TOYOTA JIDOSHA KABUSHIKI KAISHA, Toyota-shi (JP)

(72) Inventors: Hiroki TAKEISHI, Machida-shi (JP); Reina YAMAMURA, Nagoya-shi (JP); Ryosuke TANIMURA, Nagoya-shi (JP)

(73) Assignee: TOYOTA JIDOSHA KABUSHIKI KAISHA, Toyota-shi (JP)

(21) Appl. No.: 19/332,668

(22) Filed: Sep. 18, 2025

(30) Foreign Application Priority Data
Oct. 4, 2024 (JP) 2024-175326

(51) Int. Cl. B60R 25/04; B60R 25/34

(52) U.S. Cl. CPC B60R 25/04; B60R 25/34; B60R 2025/0415

(57) ABSTRACT

A vehicle control device includes a processor. The processor is configured to acquire vehicle state information indicating a plurality of states of a target vehicle in which engine immobilization is to be enabled, is configured to determine a state of the target vehicle, based on the vehicle state information, by comparing the states of the target vehicle with respective corresponding conditions one after another in a predetermined order, and is configured to enable the engine immobilization in the target vehicle when the states meet the corresponding conditions respectively in the predetermined order.

### CROSS-REFERENCE TO RELATED APPLICATION

This application claims priority to Japanese Patent Application No. 2024-175326 filed on October 4, 2024. The disclosure of the above-identified application, including the specification, drawings, and claims, is incorporated by reference herein in its entirety.

### BACKGROUND

### 1. Technical Field

The present disclosure relates to a vehicle control device.

### 2. Description of Related Art

Japanese Patent No. 6647509 (JP 6647509 B) discloses a technology in which an individual or corporate person (for example, a vehicle holder or the like) other than a user of a vehicle performs engine immobilization for reasons of the protection of receivables or safety. To ensure user safety, the engine immobilization makes it a condition of enabling engine immobilization that, for example, the current position of the vehicle is at a specific location, the vehicle is not traveling, or the like.

### SUMMARY

However, with the technology disclosed in JP 6647509 B, for example, it is difficult to accurately determine whether the vehicle is not being used and then perform engine immobilization, and there is room for improvement in terms of ensuring user safety.

The present disclosure has been made in view of the foregoing, and a vehicle control device that can enable engine immobilization is provided while the safety of a user of a vehicle is ensured.

A vehicle control device according to a first aspect of the present disclosure includes a processor, and the processor is configured to acquire vehicle state information indicating a plurality of states of a target vehicle in which engine immobilization is to be enabled, determine a state of the target vehicle, based on the vehicle state information, by comparing the states of the target vehicle with respective corresponding conditions one after another in a predetermined order, and enable the engine immobilization in the target vehicle when the states meet the conditions respectively in the predetermined order.

In the vehicle control device according to the first aspect of the present disclosure, the states may be at least two states among a state of an ignition of the target vehicle, a state where elapsed time since the ignition of the target vehicle entered an off state is a predetermined period of time or more, an illumination state of a lamp included in the target vehicle, a charge state of the target vehicle, and a state where a smart key configured to lock and unlock the target vehicle is inside or outside of the target vehicle.

In the vehicle control device according to the first aspect of the present disclosure, the determination of the state of the target vehicle by comparing the states of the target vehicle with the respective corresponding conditions one after another in the predetermined order may include processing of comparing the states of the target vehicle, one after another in the predetermined order, with at least two conditions corresponding to the states among conditions including whether an ignition of the target vehicle is in an off state, whether a state holds where elapsed time since the ignition of the target vehicle entered the off state is a predetermined period of time or more, whether the illumination state of a lamp included in the target vehicle is an extinguished state, whether the charge state of the target vehicle is a state of being charged, and whether a smart key configured to lock and unlock the target vehicle is in a state of being outside of the target vehicle.

In the vehicle control device according to the first aspect of the present disclosure, the corresponding conditions may include a first condition, a second condition, a third condition and a fourth condition, the determination of the state of the target vehicle by comparing the states of the target vehicle with the respective corresponding conditions one after another in the predetermined order may include processing of comparing the states of the target vehicle with the corresponding conditions in the order of the first condition to the fourth condition as long as an antecedent one of the corresponding conditions is met, the first condition may be a condition of whether an ignition of the target vehicle is in an off state, the second condition may be a condition of whether a state holds where elapsed time since the ignition of the target vehicle entered the off state is a predetermined period of time or more, the third condition may be a condition of whether the illumination state of a lamp included in the target vehicle is an extinguished state, and the fourth condition may be a condition of whether a smart key configured to lock and unlock the target vehicle is in a state of being outside of the target vehicle.

In the vehicle control device according to the first aspect of the present disclosure, the target vehicle may be any one of a BEV and a PHEV, the corresponding conditions may include a first condition, a second condition, a third condition, a fourth condition and a fifth condition, the determination of the state of the target vehicle by comparing the states of the target vehicle with the respective corresponding conditions one after another in the predetermined order may include processing of comparing the states of the target vehicle with the corresponding conditions in the order of the first condition to the fifth condition as long as an antecedent one of the corresponding conditions is met, the first condition may be a condition of whether an ignition of the target vehicle is in an off state, the second condition may be a condition of whether a state holds where elapsed time since the ignition of the target vehicle entered the off state is a predetermined period of time or more, the third condition may be a condition of whether the illumination state of a lamp included in the target vehicle is an extinguished state, the fourth condition may be a condition of whether the charge state of the target vehicle is a state of being charged, and the fifth condition may be a condition of whether a smart key configured to lock and unlock the target vehicle is in a state of being outside of the target vehicle.

In the vehicle control device according to the first aspect of the present disclosure, the processor may be configured to terminate the determination at a time when one of the conditions is not met.

The present disclosure brings about the advantageous effect that engine immobilization can be enabled while the safety of a user of a vehicle is ensured.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a block diagram showing a schematic configuration of a vehicle control system according to an embodiment;

FIG. 2 is a sequence chart showing an example of information exchanges between a receivables recovery server, a vehicle information server, and a vehicle included in the vehicle control system according to the embodiment;

FIG. 3 is a flowchart showing an outline of processing that the receivables recovery server according to the embodiment executes;

FIG. 4 is a flowchart showing an outline of processing that the vehicle information server according to the embodiment executes when vehicle state information is transmitted to a receivables recovery server 1;

FIG. 5 is a flowchart showing an outline of processing that the vehicle information server according to the embodiment executes when engine immobilization in a vehicle 4 is to be enabled;

FIG. 6 is a flowchart showing an outline of processing that the vehicle according to the embodiment executes when vehicle state information is transmitted to a vehicle information server 3; and

FIG. 7 is a flowchart showing an outline of processing that the vehicle according to the embodiment executes when engine immobilization is enabled.

### DETAILED DESCRIPTION OF EMBODIMENTS

Hereinafter, a vehicle control device according to an embodiment of the present disclosure is described with reference to the drawings. Note that constituent elements in the embodiment below encompass those with which the constituent elements can be replaced easily by a person skilled in the art, or those that are substantially identical to the constituent elements.

### Vehicle Control System

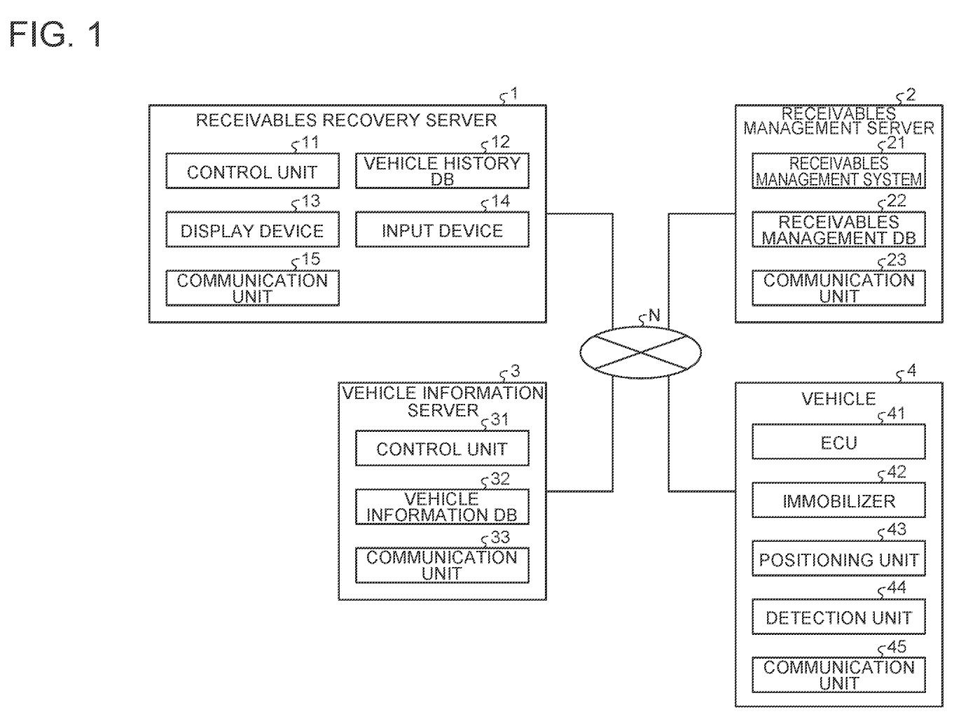

FIG. 1 is a block diagram showing a schematic configuration of a vehicle control system according to the embodiment. The vehicle control system shown in FIG. 1 includes a receivables recovery server 1, a receivables management server 2, a vehicle information server 3, and a vehicle 4. The receivables recovery server 1, the receivables management server 2, the vehicle information server 3, and the vehicle 4 each include a communication function, and are configured to be able to communicate and exchange various kinds of information with each other through a network N. For example, the network N includes a public line network, such as an internet line network or a mobile telephone line network. In the vehicle control system according to the embodiment, the receivables recovery server 1 functions as a vehicle control device that controls actions (particularly, engine immobilization) in the vehicle 4.

### Receivables Recovery Server

First, a functional configuration of the receivables recovery server 1 is described.

The receivables recovery server 1 controls the vehicle 4 remotely to recover receivables related to the vehicle 4. In the embodiment, examples of the "receivables" include receivables related to an installment contract entered into at the time of purchase of the vehicle, receivables related to an agreement for a lease on the vehicle 4, receivables related to an agreement for a subscription to the vehicle 4, receivables related to an agreement for rental of the vehicle 4, and the like.

A creditor in the embodiment is, for example, the holder (owner) of the vehicle 4. Specifically, examples of the creditor include a dealer that has sold the vehicle 4, a credit company, a bank, and the like. A debtor in the embodiment is, for example, a user of the vehicle 4. Specifically, examples of the debtor include the purchaser of the vehicle 4, a person or a business company that has entered into a lease agreement or the like, and the like.

As shown in FIG. 1, the receivables recovery server 1 includes a control unit 11, a vehicle history DB 12, a display device 13, an input device 14, and a communication unit 15.

The control unit 11 is implemented by, for example, a processor including a central processing unit (CPU) or the like, and memory (a main storage unit) including a random-access memory (RAM), a read-only memory (ROM), and the like. When the vehicle 4 meets a predetermined requirement for engine immobilization (hereinafter, referred to as "engine immobilization requirement"), the control unit 11 acquires predetermined information from the vehicle history DB 12 or the vehicle information server 3, determines, based on the information, whether to enable engine immobilization, and enables engine immobilization in the vehicle 4, according to a result of the determination.

Examples of the "engine immobilization requirement" include a case where a user of the vehicle 4 is in debt default (late repayment), or the like. Determination of whether the engine immobilization requirement is met is performed by, for example, the receivables recovery server 1. When there is a vehicle 4 (target vehicle) that meets the engine immobilization requirement, information for identifying the vehicle 4 (for example, the vehicle identification number (VIN) or the like) is transmitted from the receivables management server 2 to the receivables recovery server 1.

Specifically, the control unit 11 receives vehicle state information indicating a plurality of states of the vehicle 4 (target vehicle) in which engine immobilization is to be enabled from the vehicle 4 (target vehicle) via the vehicle information server 3. Subsequently, based on the vehicle state information on the vehicle 4 (target vehicle), the control unit 11 determines a state of the vehicle 4 by comparing the states of the vehicle 4 with respective corresponding conditions one after another in a predetermined order. When the states of the vehicle 4 meet the corresponding conditions respectively in the predetermined order, the control unit 11 transmits an engine immobilization enabling request to enable engine immobilization in the vehicle 4 to the vehicle 4 via the vehicle information server 3.

Here, the states are at least two states among a state of an ignition of the vehicle 4, a state where elapsed time since the ignition of the vehicle 4 entered an off state (IG-OFF state) is a predetermined period of time or more (for example, five minutes or more), illumination states of lamps included in the vehicle 4, a charge state of the vehicle 4, and a state where a smart key that locks and unlocks the vehicle 4 is inside or outside of the vehicle 4.

For example, when the control unit 11 determines a state of the vehicle 4 by comparing the states of the vehicle 4 with the respective corresponding conditions one after another in the predetermined order, the control unit 11 performs the determination by comparing the states of the vehicle 4, one after another in the predetermined order, with at least two corresponding conditions among whether the ignition of the vehicle 4 is in the off state, whether the state holds where elapsed time since the ignition of the vehicle 4 entered the off state is the predetermined period of time or more, whether the illumination states of the lamps included in the vehicle 4 are extinguished states, whether the charge state of the vehicle 4 is a state of being charged, and whether the smart key that locks and unlocks the vehicle 4 is in a state of being outside of the vehicle 4. For example, the control unit 11 performs the determination by comparison with each of the conditions of (1) whether the ignition of the vehicle 4 is in the off state, (2) whether the state holds where elapsed time since the ignition of the vehicle 4 entered the off state is the predetermined period of time or more, (3) whether the illumination states of the lamps included in the vehicle 4 are the extinguished states, (4) whether the charge state of the vehicle 4 is the state of being charged, and (5) whether the smart key that locks and unlocks the vehicle 4 is in the state of being outside of the vehicle 4, in the order of (1), (2), (3), (4), (5) above as long as each antecedent one of the conditions is met. In other words, the predetermined order is the order of (1), (2), (3), (4), (5) above. Note that in the embodiment, not all the conditions (1), (2), (3), (4), (5) need to be met, and states that meet at least two of the conditions may suffice.

As described above, the receivables recovery server 1 acquires the predetermined information from the vehicle history DB 12 or the vehicle information server 3, determines, based on the information, whether to enable engine immobilization, and enables engine immobilization in the vehicle 4 remotely, according to a result of the determination. Thus, the determination of enabling of engine immobilization in the vehicle 4 can be performed more safely. Note that when engine immobilization in the vehicle 4 (target vehicle) is to be enabled, the control unit 11 may display information related to the vehicle 4 (target vehicle) on the display device 13 and, in response to an instruction signal input according to an operation of the input device 14 by an operator operating the receivables recovery server 1, may transmit an engine immobilization enabling request to enable engine immobilization to the vehicle 4. Thus, seeking of final determination as to enabling of engine immobilization from the operator makes it possible for the operator to make an advance notice about enabling of engine immobilization to the debtor of the vehicle 4.

The vehicle history DB 12 is a database that is configured by using a hard disk drive (HDD), a solid state drive (SSD), or the like, and accumulates various kinds of information related to the vehicle 4. For example, the vehicle history DB 12 acquires vehicle state information from the vehicle information server 3 and accumulates the vehicle state information in association with a vehicle identification number (VIN) or the like. The vehicle history DB 12 creates steady stop position information, based on the vehicle state information accumulated in the vehicle history DB 12.

The display device 13 is implemented by, for example, a liquid crystal display (LCD), an organic electroluminescence display (OLED), or the like. The display device 13 displays various kinds of information under control of the control unit 11.

The input device 14 is implemented by, for example, a touch panel, a keyboard, a pointing device, or the like. The input device 14 receives input of various operations made by a user and outputs signals according to the received operations to the control unit 11.

The communication unit 15 is configured by using, for example, a local area network (LAN) interface board, a wireless communication circuit for wireless communication, and the like. The communication unit 15, under control of the control unit 11, performs information exchanges with the receivables management server 2 and the vehicle information server 3 through communication over the network N.

### Receivables Management Server

Next, a functional configuration of the receivables management server 2 is described.

The receivables management server 2 is a server for managing receivables related to the vehicle 4. The receivables management server 2 includes a receivables management system 21, a receivables management DB 22, and a communication unit 23.

Among a plurality of vehicles 4 managed in the receivables management DB 22, when there is a vehicle 4 (target vehicle) that meets the engine immobilization requirement, the receivables management system 21 transmits information for identifying the vehicle 4 (for example, the vehicle identification number (VIN) or the like) to the receivables recovery server 1.

The receivables management DB 22 manages information for identifying each vehicle 4 and information related to receivables from the vehicle 4 in association with each other. Here, the information for identifying each vehicle 4 is, for example, a vehicle identification number (VIN) or the like. The information related to receivables from the vehicle 4 includes, for example, loan receivables, lease receivables, and the like.

The communication unit 23 is configured by using, for example, a LAN interface board, a wireless communication circuit for wireless communication, and the like. The communication unit 23 performs information exchanges with the receivables recovery server 1 through communication over the network N.

### Vehicle Information Server

Next, a functional configuration of the vehicle information server 3 is described.

The vehicle information server 3 is a server that acquires vehicle state information from the vehicle 4, according to a request from the receivables recovery server 1, and transmits the acquired vehicle state information to the receivables recovery server 1. The vehicle information server 3 includes a control unit 31, a vehicle information DB 32, and a communication unit 33.

The control unit 31 is implemented by, for example, a processor including a CPU or the like, and memory (a main storage unit) including a RAM, a ROM, and the like. The control unit 31 acquires vehicle state information from the vehicle 4, according to a request from the receivables recovery server 1, and transmits the acquired vehicle state information to the receivables recovery server 1.

The vehicle information DB 32 accumulates vehicle state information acquired from the vehicle 4 (target vehicle) and information for identifying the vehicle 4 (for example, the vehicle identification number (VIN) or the like) in association with each other. The vehicle information DB 32 transmits vehicle state information to the receivables recovery server 1, according to a request from the receivables recovery server 1.

The communication unit 33 is configured by using, for example, a LAN interface board, a wireless communication circuit for wireless communication, and the like. The communication unit 33 performs information exchanges with the receivables recovery server 1, the receivables management server 2, and the vehicle 4 through communication over the network N.

### Vehicle

Next, a functional configuration of the vehicle 4 is described.

For example, the vehicle 4 is a general engine vehicle (conventional vehicle), a hybrid electric vehicle (HEV), a plug-in hybrid electric vehicle (PHEV), or the like. For example, the vehicle 4 may be a fuel cell electric vehicle (FCEV), a battery electric vehicle (BEV), or the like. The vehicle 4 includes an ECU 41, an immobilizer 42, a positioning unit 43, a detection unit 44, and a communication unit 45.

The ECU 41 is an electronic control unit that includes, as a main component, a microcomputer including, for example, a CPU, a ROM, a RAM, and the like. The ECU 41 transmits vehicle state information to the vehicle information server 3, according to a request from the receivables recovery server 1 via the vehicle information server 3. The ECU 41 acquires vehicle state information on the vehicle 4 detected by the positioning unit 43 and the detection unit 44 individually, and transmits the vehicle state information to the receivables recovery server 1 via the vehicle information server 3. Further, the ECU 41 enables engine immobilization in the vehicle 4, in response to an instruction signal that instructs enabling of engine immobilization, transmitted from the receivables recovery server 1 via the vehicle information server 3. In other words, the ECU 41 does not start an engine of the vehicle 4 even if the debtor depresses an ignition switch to start the engine of the vehicle 4. In such a case, the ECU 41 may cause an undepicted monitor to display information indicating that engine immobilization has been enabled due to a late repayment of the debt, or to display contact information on the creditor.

The immobilizer 42 performs enabling of engine immobilization or release of enabled engine immobilization, based on control by the vehicle information server 3.

The positioning unit 43 detects the current position of the vehicle 4, for example, by receiving radio waves from global positioning system (GPS) satellites. Note that a method for detecting the current position of the vehicle 4 is not limited to the method using the GPS satellites, and for example, a method in which light detection and ranging or laser imaging detection and ranging (LiDAR) and a 3D map are combined, or the like may be used.

The detection unit 44 detects the state of the ignition switch included in the vehicle 4, detects elapsed time since the ignition entered the off state, detects the illumination states of the lamps included in the vehicle 4, detects the charge state of the vehicle 4, detects the smart key that locks and unlocks the vehicle 4, and detects whether the smart key is outside or inside of the vehicle 4. The detection unit 44 is configured by using a timer, a voltage sensor, a current sensor, an on-off switch detection sensor, a wireless receiver, and the like.

The communication unit 45 is configured by using, for example, a data communication module (DCM) or the like. The communication unit 45 performs information exchanges with the vehicle information server 3 through communication over the network N.

### Information Exchanges between Receivables Recovery Server, Vehicle Information Server, Vehicle

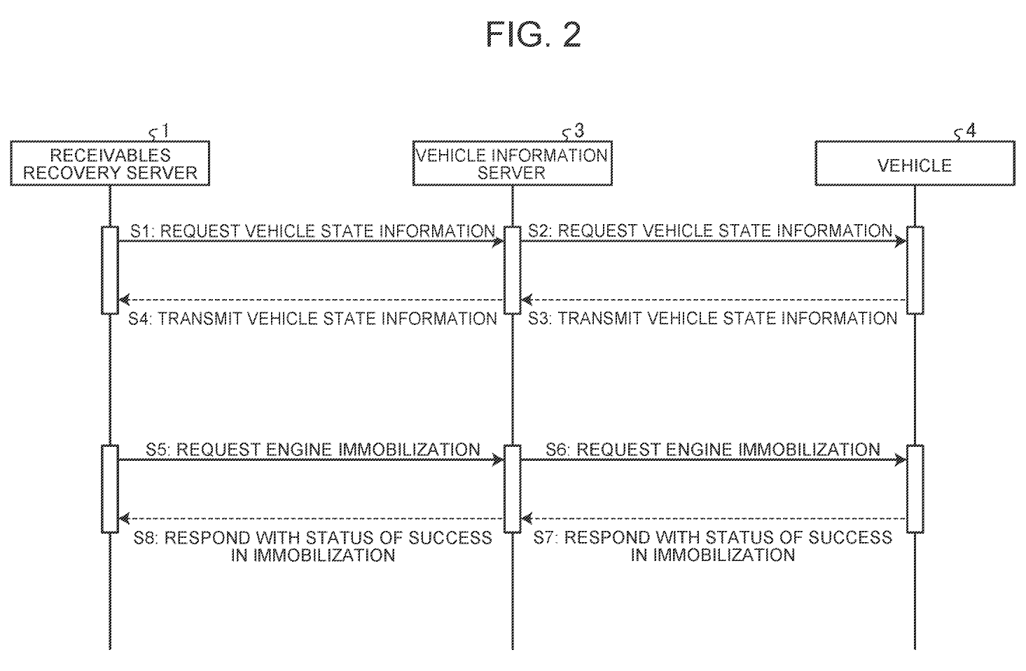

Next, information exchanges between the receivables recovery server 1, the vehicle information server 3, and the vehicle 4 are described. FIG. 2 is a sequence chart showing an example of the information exchanges between the receivables recovery server 1, the vehicle information server 3, and the vehicle 4. Note that in the following processing, a description is given of, as an example, processing that is performed with respect to a vehicle 4, among a plurality of vehicles 4, that is used by a debtor who delays repaying the debt.

As shown in FIG. 2, first, the control unit 11 of the receivables recovery server 1 requests vehicle state information from the vehicle information server 3, for example, at regular intervals (step S1). Subsequently, based on the request for vehicle state information received from the receivables recovery server 1, the vehicle information server 3 requests vehicle state information from the vehicle 4 (step S2). In response thereto, the vehicle 4 transmits vehicle state information detected by the positioning unit 43 and the detection unit 44 to the vehicle information server 3 (step S3). Subsequently, the vehicle information server 3 transmits the vehicle state information received from the vehicle 4 to the receivables recovery server 1 (step S4). In such a case, the receivables recovery server 1 accumulates, in the vehicle history DB 12, the vehicle state information on the vehicle 4 received from the vehicle information server 3 in association with the vehicle identification number (VIN) of the vehicle 4.

Moreover, when a plurality of states included in the vehicle state information on the target vehicle 4 meets respective corresponding conditions, which will be described later, one after another in the predetermined order, the control unit 11 of the receivables recovery server 1, triggered by the fact that the engine immobilization requirement is met, makes a request to perform engine immobilization to the vehicle information server 3 (step S5). Subsequently, based on the request to perform engine immobilization received from the receivables recovery server 1, the vehicle information server 3 makes a request to perform engine immobilization to the vehicle 4 (step S6). In response thereto, the vehicle 4 performs engine immobilization, and gives a response indicating status of success in engine immobilization to the vehicle information server 3 (step S7). Thereafter, the vehicle information server 3 transmits the response indicating the status of success in immobilization received from the vehicle 4 to the receivables recovery server 1 (step S8). In such a case, the receivables recovery server 1 accumulates, in the vehicle history DB 12, the status of success in immobilization of the vehicle 4 received from the vehicle information server 3 in association with the vehicle identification number (VIN) of the vehicle 4.

### Processing by Receivables Recovery Server

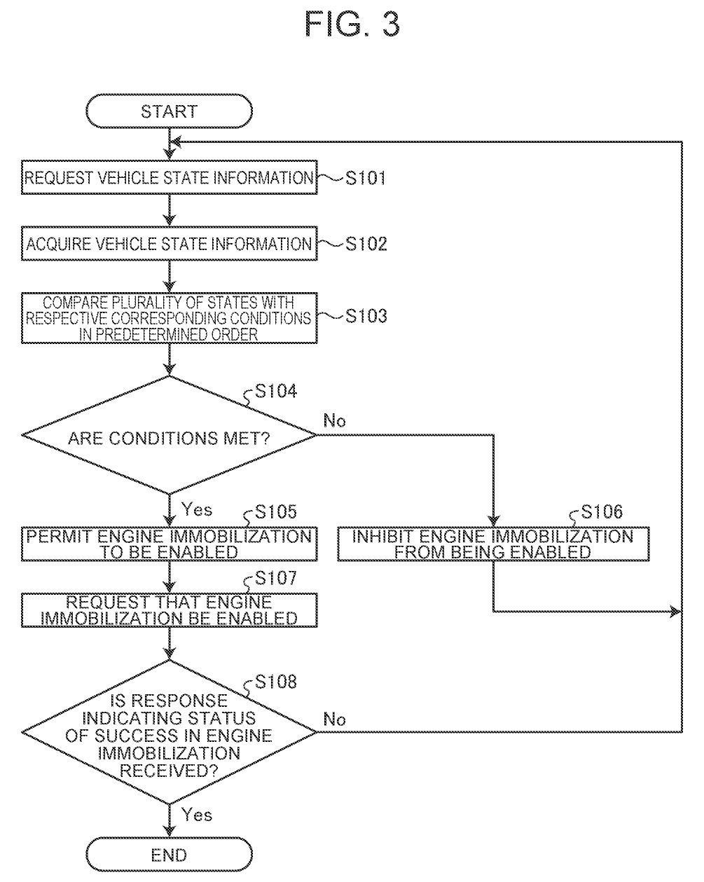

Next, processing that the receivables recovery server 1 executes is described. FIG. 3 is a flowchart showing an outline of the processing that the receivables recovery server 1 executes.

As shown in FIG. 3, the control unit 11 requests vehicle state information on the vehicle 4 via the vehicle information server 3 (step S101), and acquires vehicle state information transmitted from the vehicle 4 (step S102).

Subsequently, the control unit 11 compares a plurality of states included in the vehicle state information on the vehicle 4 with respective corresponding conditions one after another in the predetermined order (step S103). Specifically, the control unit 11 determines (1) whether the ignition of the vehicle 4 is in the off state (first condition), (2) whether the state holds where elapsed time since the ignition of the vehicle 4 entered the off state is the predetermined period of time or more (second condition), (3) whether the illumination states of the lamps included in the vehicle 4 are the extinguished states (third condition), and (4) whether the smart key that locks and unlocks the vehicle 4 is in the state of being outside of the vehicle 4 (fourth condition), by comparison with the corresponding conditions in the order of (1), (2), (3), and (4) above as long as each antecedent condition is met. In other words, the corresponding conditions may include the first condition to the fourth condition. Determination of a state of the target vehicle by comparing the states of the target vehicle with the respective corresponding conditions one after another in the predetermined order may include processing of comparing the states of the target vehicle with the corresponding conditions in the order of the first condition to the fourth condition as long as the antecedent corresponding condition is met. Note that when the vehicle 4 is either a BEV or a PHEV, the control unit 11 determines (1) whether the ignition of the vehicle 4 is in the off state (first condition), (2) whether the state holds where elapsed time since the ignition of the vehicle 4 entered the off state is the predetermined period of time or more (second condition), (3) whether the illumination states of the lamps included in the vehicle 4 are the extinguished states (third condition), (4) whether the charge state of the vehicle 4 is the state of being charged (fourth condition), and (5) whether the smart key that locks and unlocks the vehicle 4 is in the state of being outside of the vehicle 4 (fifth condition), by comparison with the corresponding conditions in the order of (1), (2), (3), (4), and (5) above as long as each antecedent condition is met. In other words, the corresponding conditions may include a first condition to a fifth condition. Determination of a state of the target vehicle by comparing the states of the target vehicle with the respective corresponding conditions one after another in the predetermined order may include processing of comparing the states of the target vehicle with the corresponding conditions in the order of the first condition to the fifth condition as long as the antecedent corresponding condition is met.

Thereafter, the control unit 11 determines whether the states included in the vehicle state information on the vehicle 4 meet all the corresponding conditions respectively in the predetermined order (step S104). When the states included in the vehicle state information on the vehicle 4 meet all the corresponding conditions respectively in the predetermined order (step S104: Yes), the control unit 11 permits engine immobilization in the vehicle 4 to be enabled (step S105), and makes a request, to the vehicle 4 via the vehicle information server 3, to enable engine immobilization in the vehicle 4 (step S107). Thus, the engine immobilization enabling request is transferred from the vehicle information server 3 to the immobilizer 42 of the vehicle 4.

Subsequently, the control unit 11 determines whether a response indicating status of success in engine immobilization is received from the vehicle 4 via the vehicle information server 3 (step S108). When a response indicating status of success in engine immobilization is received from the vehicle 4 via the vehicle information server 3 (step S108: Yes), the control unit 11 terminates the present processing. In contrast, when a response indicating status of success in engine immobilization is not received from the vehicle 4 via the vehicle information server 3 (step S108: No), the control unit 11 returns to step S101. Note that examples of a case where enabling of engine immobilization fails include a case where the engine immobilization enabling request cannot be transmitted from the vehicle information server 3 to the immobilizer 42 of the vehicle 4 due to bad communication or the like, a case where a malfunction occurs in the immobilizer 42 of the vehicle 4, a case where the vehicle state information on the vehicle 4 changes immediately after the engine immobilization enabling request is made, and the like.

In step S104, the states included in the vehicle state information on the vehicle 4 do not meet the respective corresponding conditions one after another in the predetermined order (step S104: No), the control unit 11 inhibits engine immobilization in the vehicle 4 from being enabled (step S106). Thus, the control unit 11 terminates the determination at a time when the states included in the vehicle state information on the vehicle 4 do not meet the corresponding conditions respectively in the predetermined order, whereby processing throughput and a communication load can be reduced. Moreover, the control unit 11 can perform determination of enabling of engine immobilization in the vehicle 4 more safely. After step S106, the control unit 11 returns to step S101.

### Processing 1 by Vehicle Information Server

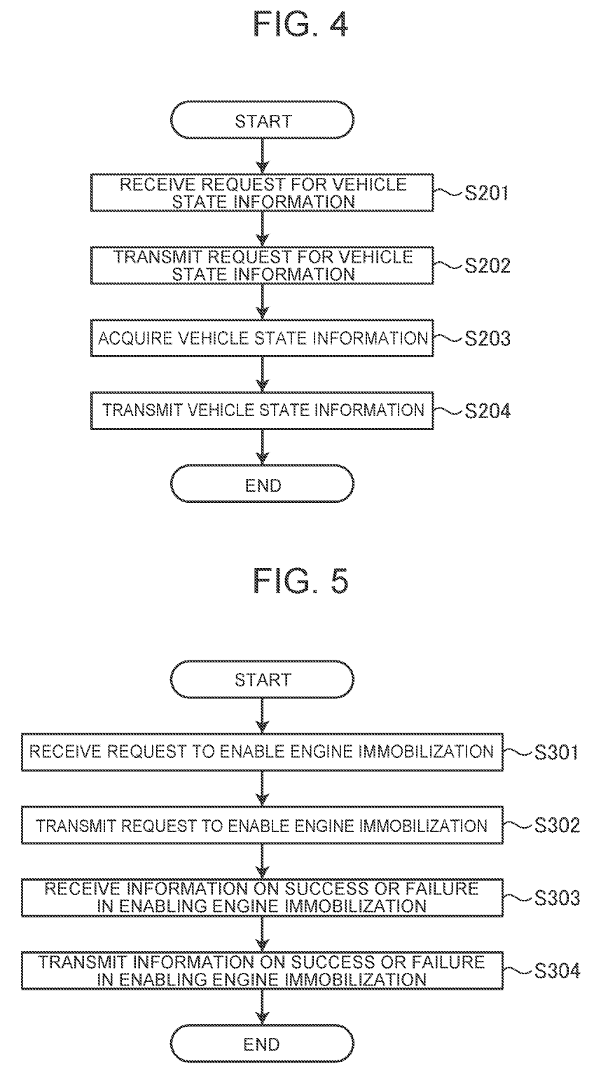

Next, a description is given of an outline of processing that the vehicle information server 3 executes when vehicle state information is transmitted to the receivables recovery server 1. FIG. 4 is a flowchart showing an outline of the processing that the vehicle information server 3 executes when vehicle state information is transmitted to the receivables recovery server 1.

As shown in FIG. 4, first, the control unit 31 receives, from the receivables recovery server 1, a request for vehicle state information (step S201), and transmits the received request for vehicle state information to the vehicle 4 (step S202).

Subsequently, the control unit 31 acquires vehicle state information from the vehicle 4 (step S203), transmits the vehicle state information acquired from the vehicle 4 to the receivables recovery server 1 (step S204), and finishes the present processing.

### Processing 2 by Vehicle Information Server

Next, a description is given of an outline of processing that the vehicle information server 3 executes when engine immobilization in the vehicle 4 is to be enabled. FIG. 5 is a flowchart showing an outline of the processing that the vehicle information server 3 executes when engine immobilization in the vehicle 4 is to be enabled.

As shown in FIG. 5, first, the control unit 31 receives, from the receivables recovery server 1, a request to enable engine immobilization (step S301), and transmits the request to enable engine immobilization received from the receivables recovery server 1 to the vehicle 4 (step S302).

Subsequently, the control unit 31 receives, from the vehicle 4, information on success or failure in enabling of engine immobilization (step S303), transmits the information on success or failure in enabling of engine immobilization received from the vehicle 4 to the receivables recovery server 1 (step S304), and finishes the present processing.

### Processing 1 by Vehicle

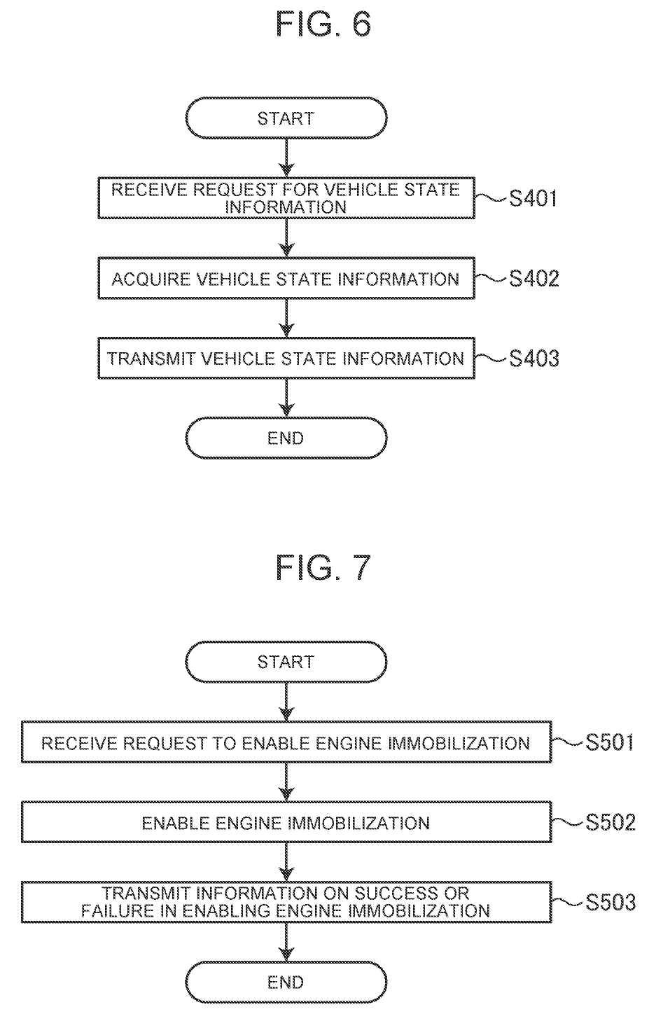

Next, a description is given of processing that the vehicle 4 executes when vehicle state information is transmitted to the vehicle information server 3. FIG. 6 is a flowchart showing an outline of the processing that the vehicle 4 executes when vehicle state information is transmitted to the vehicle information server 3.

As shown in FIG. 6, first, the ECU 41 receives, from the vehicle information server 3, a request for vehicle state information (step S401), and acquires vehicle state information on the vehicle 4 from the positioning unit 43 and the detection unit 44 (step S402). Subsequently, the ECU 41 transmits the vehicle state information on the vehicle 4 to the vehicle information server 3 (step S403), and finishes the present processing.

### Processing 2 by Vehicle

Next, a description is given of an outline of processing that the vehicle 4 executes when enabling engine immobilization. FIG. 7 is a flowchart showing an outline of the processing that the vehicle 4 executes when engine immobilization is enabled.

As shown in FIG. 7, first, the ECU 41 receives, from the vehicle information server 3, a request to enable engine immobilization (step S501). Engine immobilization is enabled through control of the immobilizer 42 (step S502). Subsequently, the ECU 41 determines, for example based on the action status of the immobilizer 42, whether or not the enabling of engine immobilization succeeds, transmits information on success or failure in enabling of engine immobilization to the vehicle information server 3 (step S503), and finishes the present processing.

According to the embodiment described hereinabove, the receivables recovery server 1 acquires predetermined information from the vehicle history DB 12 or the vehicle information server 3, determines, based on the information, whether to enable engine immobilization, and enables engine immobilization in the vehicle 4 remotely, according to a result of the determination. Thus, engine immobilization in the vehicle 4 can be enabled safely.

Moreover, according to the embodiment, the receivables recovery server 1 determines a plurality of states in the predetermined order in determination of a state of the vehicle 4, and the determination is terminated at a time when a condition is not met. Accordingly, processing and communication loads can be reduced. In other words, the processor is configured to terminate the determination at a time when one of the conditions is not met.

More advantageous effects and modification examples can be easily derived by a person skilled in the art. Accordingly, boarder aspects of the present disclosure are not limited to the specific details and the typical embodiment as presented and described above. Accordingly, various changes can be made without departing from the spirit or the scope of the comprehensive concept of the disclosure defined by the accompanying claims and their equivalents.

For example, although the description is premised on the receivables recovery server 1 in the embodiment, the vehicle 4 may be configured to have functionality per se. In such a case, the vehicle 4 may include the functionality of the control unit 11 and the vehicle history DB 12 of the receivables recovery server 1. In the vehicle control device according to the embodiment, the vehicle 4 may be configured to undertake part of the processing by the receivables recovery server 1 or the vehicle information server 3.

For example, the description is premised on the assumption that the receivables recovery server 1 functions as a vehicle control device in the embodiment, however, the vehicle 4 itself may function as a vehicle control device. In such a case, the vehicle 4 may include the functionality of the control unit 11 and the vehicle history DB 12 of the receivables recovery server 1. In the vehicle control device according to the embodiment, the vehicle 4 may be configured to undertake part of the processing by the receivables recovery server 1 or the vehicle information server 3.

For example, all of the following (1) to (5) may be performed by the receivables recovery server 1, or may be performed by the vehicle 4, or alternatively, (1) to (4) may be performed by the vehicle 4, and (5) may be performed by the receivables recovery server 1.

(1) Determination of whether the ignition of the vehicle 4 is in the off state

(2) Determination of whether the state holds where elapsed time since the ignition of the vehicle 4 entered the off state is the predetermined period of time or more

(3) Determination of whether the illumination states of the lamps included in the vehicle 4 are the distinguished states

(4) Determination of whether the charge state of the vehicle 4 is the state of being charged

(5) Determination of whether the smart key that locks and unlocks the vehicle 4 is in the state of being outside of the vehicle 4

Furthermore, although the receivables recovery server 1, the receivables management server 2, and the vehicle information server 3 are described as individual separated devices in the embodiment, the receivables recovery server 1, the receivables management server 2, and the vehicle information server 3 may be configured as one device, or two, or four or more, devices.

What is claimed is:

1. A vehicle control device comprising a processor, wherein
the processor is configured to:
acquire vehicle state information indicating a plurality of states of a target vehicle in which engine immobilization is to be enabled;
determine a state of the target vehicle, based on the vehicle state information, by comparing the states of the target vehicle with respective corresponding conditions one after another in a predetermined order; and
enable the engine immobilization in the target vehicle when the states meet the conditions respectively in the predetermined order.

2. The vehicle control device according to claim 1, wherein the states are at least two states among a state of an ignition of the target vehicle, a state where elapsed time since the ignition of the target vehicle entered an off state is a predetermined period of time or more, an illumination state of a lamp included in the target vehicle, a charge state of the target vehicle, and a state where a smart key configured to lock and unlock the target vehicle is inside or outside of the target vehicle.

3. The vehicle control device according to claim 1, wherein the determination of the state of the target vehicle by comparing the states of the target vehicle with the respective corresponding conditions one after another in the predetermined order includes processing of comparing the states of the target vehicle, one after another in the predetermined order, with at least two conditions corresponding to the states among conditions including
whether an ignition of the target vehicle is in an off state,
whether a state holds where elapsed time since the ignition of the target vehicle entered the off state is a predetermined period of time or more,
whether an illumination state of a lamp included in the target vehicle is an extinguished state,
whether a charge state of the target vehicle is a state of being charged, and
whether a smart key configured to lock and unlock the target vehicle is in a state of being outside of the target vehicle.

4. The vehicle control device according to claim 1, wherein:
the corresponding conditions include a first condition, a second condition, a third condition and a fourth condition;
the determination of the state of the target vehicle by comparing the states of the target vehicle with the respective corresponding conditions one after another in the predetermined order includes processing of comparing the states of the target vehicle with the corresponding conditions in the order of the first condition to the fourth condition as long as the antecedent corresponding condition is met;
the first condition is a condition of whether an ignition of the target vehicle is in an off state;
the second condition is a condition of whether a state holds where elapsed time since the ignition of the target vehicle entered the off state is a predetermined period of time or more;
the third condition is a condition of whether an illumination state of a lamp included in the target vehicle is an extinguished state; and
the fourth condition is a condition of whether a smart key configured to lock and unlock the target vehicle is in a state of being outside of the target vehicle.

5. The vehicle control device according to claim 1, wherein:
the target vehicle is any one of a BEV and a PHEV;
the corresponding conditions include a first condition, a second condition, a third condition, a fourth condition and a fifth condition;
the determination of the state of the target vehicle by comparing the states of the target vehicle with the respective corresponding conditions one after another in the predetermined order includes processing of comparing the states of the target vehicle with the corresponding conditions in the order of the first condition to the fifth condition as long as the antecedent corresponding condition is met;
the first condition is a condition of whether an ignition of the target vehicle is in an off state;
the second condition is a condition of whether a state holds where elapsed time since the ignition of the target vehicle entered the off state is a predetermined period of time or more;
the third condition is a condition of whether an illumination state of a lamp included in the target vehicle is an extinguished state;
the fourth condition is a condition of whether a charge state of the target vehicle is a state of being charged; and
the fifth condition is a condition of whether a smart key configured to lock and unlock the target vehicle is in a state of being outside of the target vehicle.

6. The vehicle control device according to claim 1, wherein the processor is configured to terminate the determination at a time when one of the conditions is not met.
